(19) United States
(12) Patent Application Publication
(10) Pub. No.: US 2014/0108014 A1
(43) Pub. Date: Apr. 17, 2014

(54) INFORMATION PROCESSING APPARATUS AND METHOD FOR CONTROLLING THE SAME

(71) Applicant: CANON KABUSHIKI KAISHA, Tokyo (JP)

(72) Inventors: Tomonori Tanaka, Ageo-shi (JP); Yasuo Okutani, Kawasaki-shi (JP)

(73) Assignee: CANON KABUSHIKI KAISHA, Tokyo (JP)

(21) Appl. No.: 14/042,921

(22) Filed: Oct. 1, 2013

(30) Foreign Application Priority Data
Oct. 11, 2012 (JP) 2012-226329

(51) Int. Cl. G10L 13/02

(52) U.S. Cl. CPC G10L 13/02
USPC 704/260

(57) ABSTRACT

The present invention is configured to display a screen that includes a voice output position with a simple operation, even when another text that does not include the voice output position is displayed by manipulation during output of a text as voice. Therefore, when an input unit 101 detects an operation by a user while outputting a text as voice, a display control unit executes processing that corresponds to this operation such as scrolling, and displays the designated part of the text. Thereafter, when the input unit 101 further detects an operation and if the detected operation and the immediately previous operation are opposite operations to each other, a text that includes a current voice output position is displayed.

### BACKGROUND OF THE INVENTION

1. Field of the Invention

The present invention relates to an information processing apparatus that has a display function and a voice output function for outputting a display content as voice.

2. Description of the Related Art

Conventionally, technologies for outputting electronic book contents as voice are known. Also, a method for marking a voice output position so as to help a user recognize the voice output position (for example, Japanese Patent Laid-Open No. 2007-102720).

However, in the conventional methods, once a page other than a page that includes a content being currently output as voice is displayed, a user loses the marking that indicates the voice output position, and takes long time to recognize the voice output position.

### SUMMARY OF THE INVENTION

The present invention was made in view of such a problem. The present description provides a technology that makes it easy to recognize a voice output position by displaying a screen including the voice output position with a simple operation, even after another text that does not include the voice output position is displayed by manipulation during output of a text as voice.

In order to solve this problem, an information processing apparatus according to the present invention includes, for example, the following configuration. That is, there is provided an information processing apparatus comprising: a display control unit configured to display a text on a screen, a voice output unit configured to output the text as voice, a detection unit configured to detect a first operation and a second operation performed by a user on the screen, and a determination unit configured to determine whether or not the second operation has a predetermined relationship with the first operation, wherein the display control unit is configured to control the screen based on determination by the determination unit.

According to the present description, it is possible to easily recognize a voice output position by displaying a screen including the voice output position with a simple operation, even when another text that does not include the voice output position is displayed by manipulation during output of a text as voice.

Further features of the present invention will become apparent from the following description of exemplary embodiments (with reference to the attached drawings).

### BRIEF DESCRIPTION OF THE DRAWINGS

FIG. 1 is a diagram illustrating an information processing apparatus according to the present invention.

FIG. 2 is a functional block diagram illustrating the information processing apparatus 101.

FIG. 3 is a diagram illustrating a hardware configuration of the information processing apparatus 101.

FIGS. 4A and 4B are flowcharts illustrating processing performed by the information processing apparatus 101.

FIG. 5 is a diagram illustrating an example of display of a touch panel 102.

FIGS. 6A and 6B are flowcharts illustrating processing performed by the information processing apparatus 101.

FIGS. 7A and 7B are flowcharts illustrating processing performed by the information processing apparatus 101.

FIGS. 8A and 8B are flowcharts illustrating processing performed by the information processing apparatus 101.

FIGS. 9A and 9B are flowcharts illustrating processing performed by the information processing apparatus 101.

FIGS. 10A to 10C are diagrams illustrating dictionary data for use for specifying operation types and directions of inputs and determining as to whether the inputs are in opposite directions.

FIG. 11 is a diagram illustrating an example of display of the touch panel 102.

FIG. 12 is a diagram illustrating an example of display of the touch panel 102.

FIGS. 13A and 13B are flowcharts illustrating processing performed by the information processing apparatus 101.

FIG. 14 is a diagram illustrating example of operation types of a plurality of inputs.

FIG. 15 is a diagram illustrating a method for calculating a screen distance.

FIG. 16 is a diagram illustrating an example of display of the touch panel 102.

FIG. 17 is a diagram illustrating modes in a case of a plurality of inputs.

FIG. 18 is a diagram supplementary illustrating operation types of inputs.

FIGS. 19A and 19B are diagrams illustrating information for specifying a voice output position.

### DESCRIPTION OF THE EMBODIMENTS

Hereinafter, embodiments according to the present invention will be described in detail with reference to the accompanied drawings.

### First Embodiment

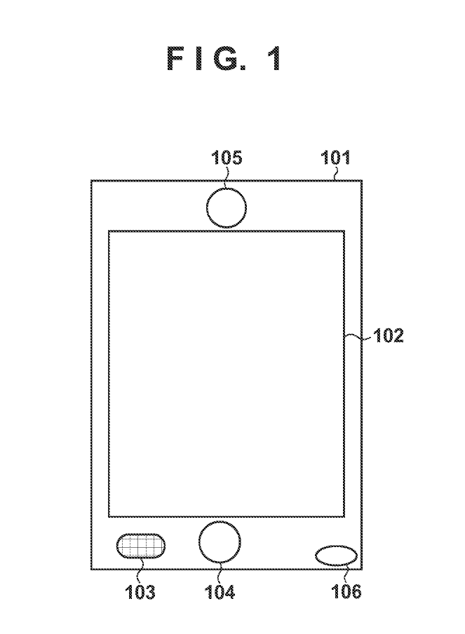

An example of outer appearance of an information processing apparatus according to the present embodiment will first be described with reference to FIG. 1. An information processing apparatus 101 shown in FIG. 1 is a portable electronic device, and is provided with a touch panel 102 that is configured by a display device such as a liquid crystal screen, and a touch panel mounted on the front face of the screen, a speaker 103, a voice output button 104, a camera 105, and an acceleration sensor 106. Note that the outer appearance of the information processing apparatus 101 is not limited to the outer appearance shown in FIG. 1, and various outer appearances are applicable. For example, a layout of the touch panel 102, the speaker 103, the voice output button 104, the camera 105, and the acceleration sensor 106 is not limited to the layout shown in FIG. 1. Also, the number of buttons, speakers, cameras, and the like may suitably be varied according to the intended purpose of the device.

The touch panel 102 serves as a screen for displaying images, characters, and the like, and also serves as a so-called touch panel, which detects a touch operation made by a pointing tool such as a user's finger and a position at which the touch operation is performed. Also, the user can input a voice output instruction to the information processing apparatus 101 by pressing the voice output button 104 with his or her finger or the like. Upon detecting this voice output instruction, the information processing apparatus 101 outputs voice (e.g., voice based on PCM WAVE data sampled at 22.05 KHz) from the speaker 103. The camera 105 uses a gesture recognition technology to detect a hand gesture of the user from information of the captured video. Note that the gesture recognition technology is well known, and thus a description thereof is omitted. The acceleration sensor 106 measures a slope and an acceleration of the information processing apparatus 101.

Note that the voice output button 104 of the embodiment has two functions. One is a function to stop outputting voice when this button is pressed while the text currently output as voice is displayed. The other is a function, when the button is pressed while no voice is being output or when the button is pressed in the state in which another position that does not include the voice output position is displayed while voice is being output, to start outputting voice from the position that is displayed at a timing at which the button is pressed.

Meanwhile, in the present embodiment, it is assumed that data of an electronic book (an electronic book content or an electronic text content) and data in a voice waveform (voice waveform data) in which the electronic book is read aloud have been downloaded in advance into a memory provided in the information processing apparatus 101. However, the present embodiment is not limited to this, and the data may be stored in an external device and suitably downloaded as needed.

The electronic book in the present embodiment is described by the Synchronized Multimedia Integration Language (SMIL), which is a markup language conforming to W3C XML. Also, the embodiments will be described on the assumption that the electronic book is displayed in Japanese. In the case of Japanese, a pronunciation is defined for each character to be displayed. Therefore, each character on each page of the electronic book is associated (synchronized) with a voice waveform position (position of a voice output character) in the voice waveform data where the character is spoken. That is, among the voice waveform data, voice waveform data of a given character on a given page of the electronic book can be uniquely specified. Also, from SMIL description information, for example, information on the page number, the block ID, the line number, the character number from the beginning of the line, and the like can be obtained. Also, by collating the information on the page number, the block ID, the line number, the character number from the beginning of the line, and the like with the SMIL description information, a voice output position on the voice waveform data and a text to which the voice output position belongs can be specified. Note that in the present embodiment, one character can be specified by the page number P, the block ID B, the line number L, and the character number i from the beginning of the line, and denoted by C_{P,B,L,i}. Also, SMIL technology is well known and thus a description thereof is omitted.

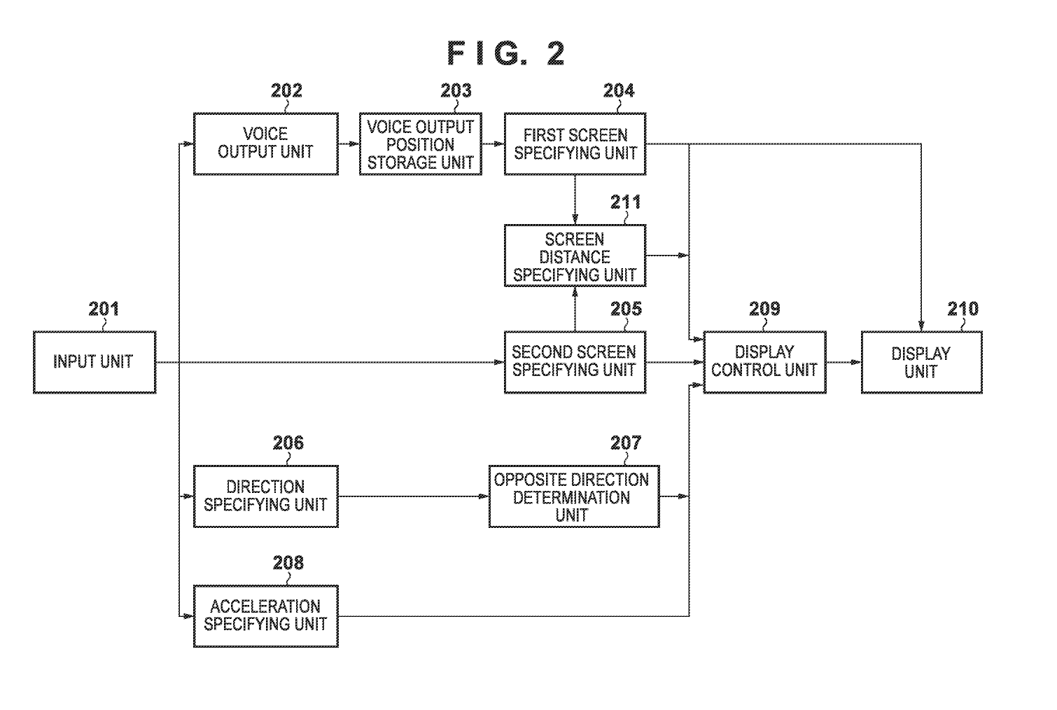

FIG. 2 is a functional block diagram illustrating a functional configuration of the information processing apparatus 101. Note that the configuration shown in FIG. 2 is an example, and some of the below-described units may be integrated, and any configuration may be adopted as long as the configuration can realize the below-described processing.

The information processing apparatus 101 includes an input unit 201, a voice output unit 202, a voice output position storage unit 203, a first screen specifying unit 204, a second screen specifying unit 205, a direction specifying unit 206, an opposite direction determination unit 207, an acceleration specifying unit 208, a display control unit 209, a display unit 210, and a screen distance specifying unit 211.

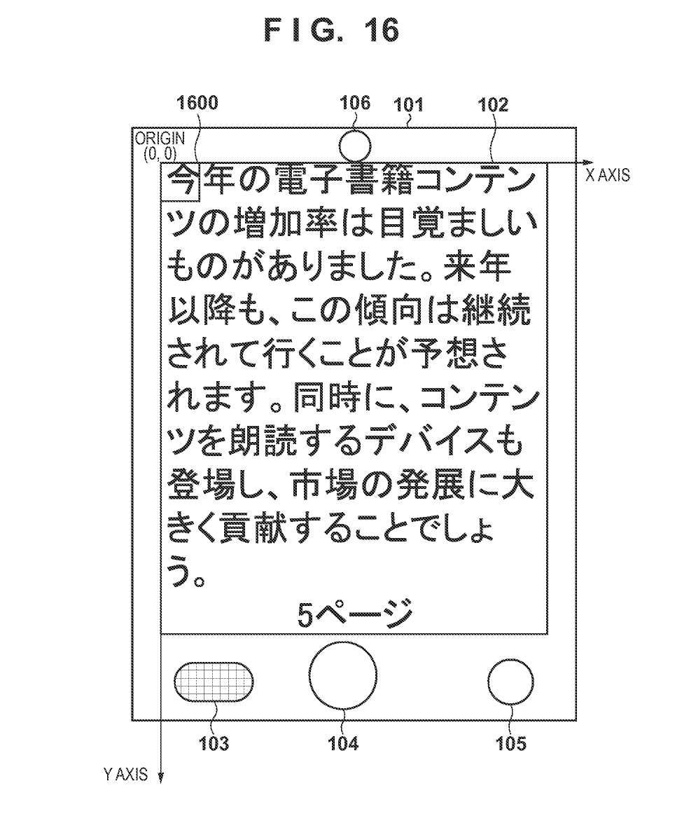

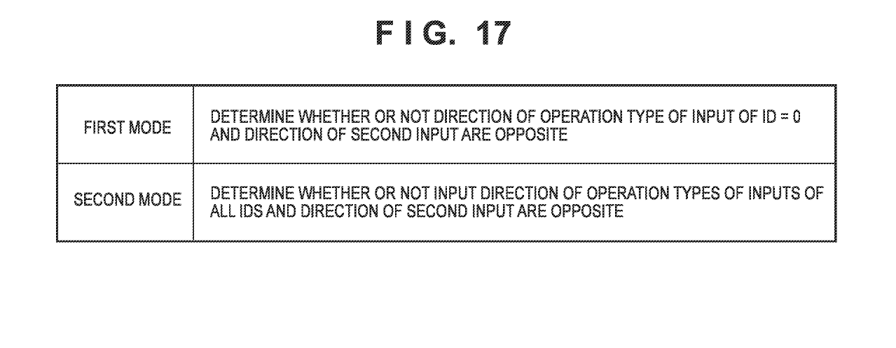

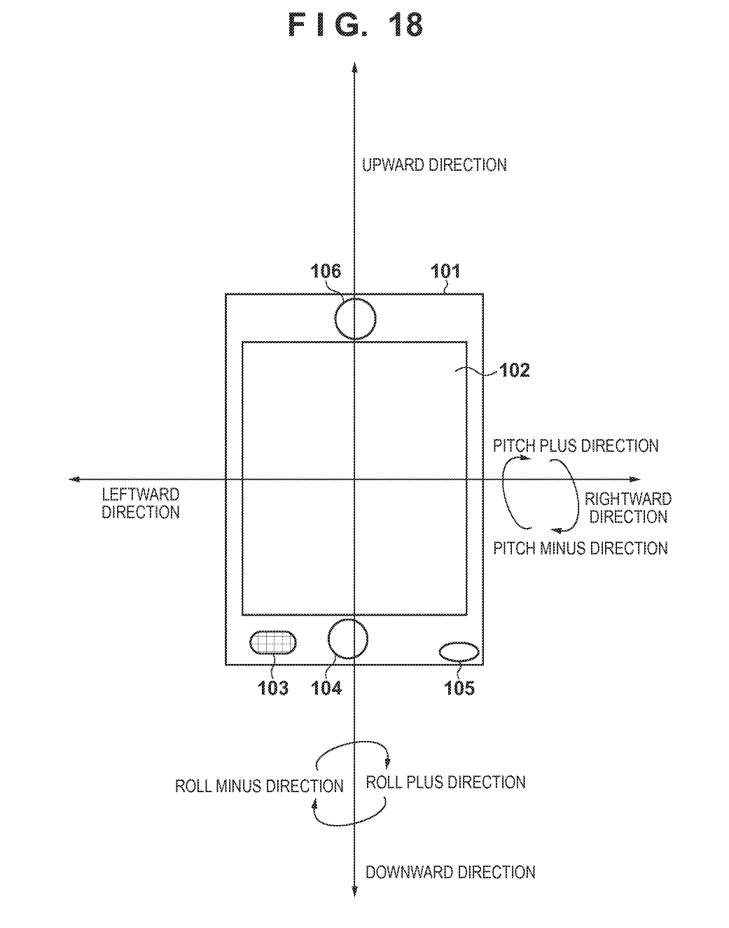

The input unit 201 detects an input to the information processing apparatus 101. A touch operation, a gesture operation, an inclination operation, pressing of the voice output button 104, and the like are detected and an operation type of the input is specified. For example, the input unit 201 specifies, as an operation type of the input, a rightward direction (leftward direction, upward direction, or downward direction) flick operation or pinching out (or pinching in) of the user performed on the touch panel 102. Also, the input unit 201 specifies, as an operation type of the input, a pitch plus direction inclination operation (pitch minus direction inclination operation, roll minus direction inclination operation, or roll plus direction inclination operation) or a pitch plus direction rotating operation (pitch minus direction rotating operation) with respect to the acceleration specifying unit 208. Also, the input unit 201 specifies, as an operation type of the input, an upward direction gesture operation (downward direction gesture operation, rightward direction gesture operation, or leftward direction gesture operation) or a grab gesture operation (release gesture operation). Note that in the present embodiment, the upward direction, the downward direction, the rightward direction, the leftward direction, the pitch minus direction, the pitch plus direction, the roll plus direction, and the roll minus direction comply with FIG. 18. Also, the details of the flick operation, the pinch operation, the gesture operation, and the inclination operation are well known, and thus descriptions thereof are omitted. Note that assuming that, for example, coordinates are set as in FIG. 16, the operation is determined as an upward direction flick operation when the Y coordinate of a touch point (XY coordinates at which the finger is in contact with the touch panel) has moved in the minus direction by a predetermined distance or greater within a predetermined time period. The operation is determined as a downward direction flick operation when the Y coordinate of the touch point has moved in the plus direction by a predetermined distance or greater within a predetermined time period. The operation is determined as a rightward direction flick operation when the X coordinate of the touch point has moved in the plus direction by a predetermined distance or greater within a predetermined time period. The operation is determined as a leftward direction flick operation when the X coordinate of the touch point has moved in the minus direction by a predetermined distance or greater within a predetermined time period.

The voice output unit 202 serves as means for reproducing text as voice, and sequentially supplies voice signals based on voice waveform data to the speaker 103 from a voice output start position (in the present embodiment, the voice output start position is assumed to be the first character of a block whose block ID is 1). When voice output of the entire electronic book content in the block is completed, the block ID is incremented (for example, the block ID is changed from 1 to 2), and voice output is performed from the first character of the electronic book content of the block whose block ID was incremented.

The voice output position storage unit 203 refers to SMIL description information and stores, in real time, information (information on the page number, the block ID, the line number, and the character number from the beginning of the line) for specifying a position of a current voice output character (voice output position) as voice output position information in a memory. For example, if the text of the second character in the third line of a block whose block ID is 1 on the fifth page is currently output as voice, the current voice output position is denoted with the page number “5”, the block ID “1”, the line number “3”, and the character number “2” from the beginning of the line.

The first screen specifying unit 204 specifies a screen that includes the voice output position stored in the voice output position storage unit 203. For example, the screen is configured such that the first character of a block of the electronic book content that is being output as voice is located at the upper left end of the touch panel 102 and a font size of the characters is 4 mm (millimeter).

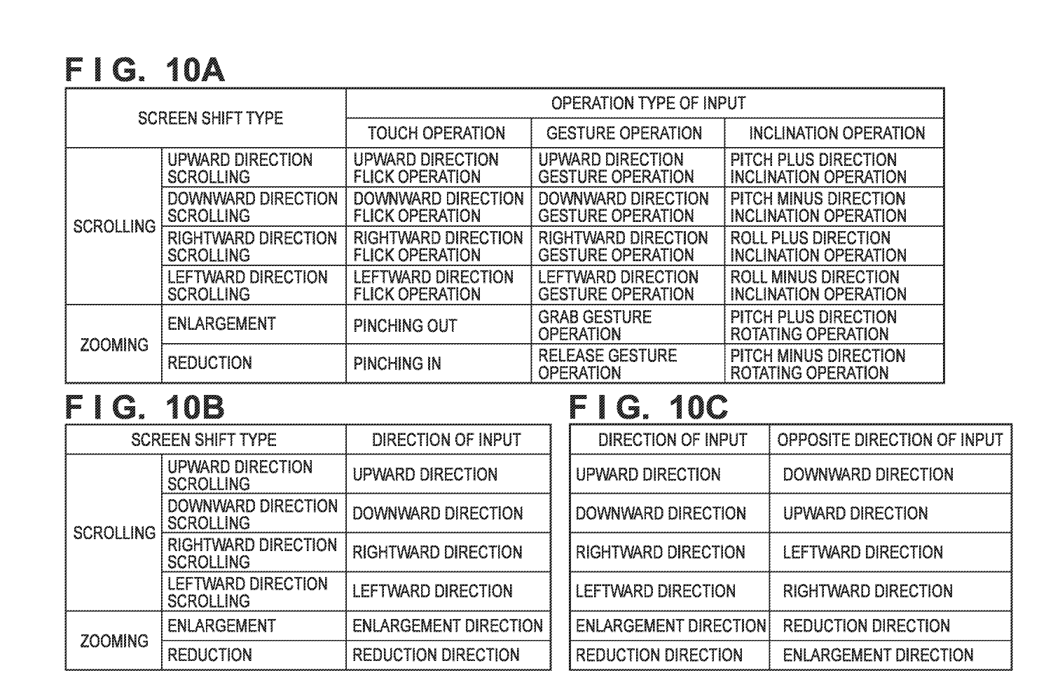

The second screen specifying unit 205 specifies a type of screen shift on the basis of a touch operation (a gesture operation or an inclination operation) detected by the input unit 201, and specifies a screen of the electronic book content that is to be displayed on the touch panel 102. Note that the types of screen shift that correspond to the operation types of inputs comply with the table of FIG. 10A. In the present embodiment, data of FIG. 10A is stored as dictionary data in a memory (e.g., a ROM). For example, when the input unit 201 detects a downward direction flick operation, the second screen specifying unit 205 refers to the dictionary data, and specifies a downward direction scroll as a type of screen shift. Also, a screen that is positioned in the lower part of the electronic book content being currently displayed on the touch panel 102 is specified as a display target that is to be scrolled and moved. Also, the second screen specifying unit 205 supplies video signals of the screens of the electronic book content to the display unit 210 in the order of scroll movement. The scroll movement of the screen is specified by the flick operation speed and a duration in which the user's finger is being in contact with the touch panel 102. Also, for example, when the input unit 201 detects pinching out (spreading), the second screen specifying unit 205 refers to the dictionary data, and specifies enlargement as a type of screen shift. Also, the screen that displays the vicinity of the center that is spread of the electronic book content that is currently displayed on the touch panel 102 is specified as a display target that is to be zoomed and moved. Also, the second screen specifying unit 205 supplies video signals of the screens of the electronic book content to the display unit 210 in the order of zoom movement. The zoom movement of the screen is specified by the pinching out operation speed and a duration in which the user's finger is being in contact with the touch panel 102.

The direction specifying unit 206 specifies a direction of the input detected by the input unit 201. Note that types of screen shift that correspond to the operation types of inputs comply with the table of FIG. 10B, for example. In the present embodiment, data of FIG. 10B is stored as dictionary data in the memory (e.g., a ROM). For example, when the input unit 201 detects a downward direction flick operation, the direction specifying unit 206 refers to the dictionary data, and specifies the downward direction as an input direction.

When the input unit 201 has detected a first input and a subsequent second input, the opposite direction determination unit 207 determines whether or not the first and second inputs are in opposite directions. In other words, when a current operation (second input) is detected, it is determined whether or not the input direction of that current operation and the input direction of the previous operation (first input) have an opposite relation. Note that inputs made in directions opposite to respective input directions comply with the table of FIG. 10C, for example. In the present embodiment, data of FIG. 10C is stored as dictionary data in a memory (e.g., ROM). For example, when the input unit 201 detects a downward direction flick operation as the first input and an upward direction flick operation as the second input, the opposite direction determination unit 207 determines that the first and second inputs are in opposite directions.

The acceleration specifying unit 208 specifies an acceleration of the input detected by the input unit 201. The acceleration of the touch operation is specified by a duration in which the user's finger is being in contact with the touch panel 102 and the moving distance of the finger. It is also assumed that the acceleration of the gesture operation is specified by the time at which the camera 105 detected the gesture operation, the moving distance, and the like. Also, the acceleration of the inclination operation is specified by the acceleration sensor 106.

The display control unit 209 switches the display between a voice output position screen specified by the first screen specifying unit 204 and a screen after input specified by the second screen specifying unit 205, according to the results of the opposite direction determination unit 207 and the acceleration specifying unit 208 (the detail will be described later).

The display unit 210 supplies a signal of video (that is, a screen of the electronic book content) based on the video signal supplied from the first screen specifying unit 204 and the second screen specifying unit 205 to the touch panel 102. In the present embodiment, video signals of the screens of the electronic book content that are specified by the first screen specifying unit 204 and the second screen specifying unit 205 are supplied to the touch panel 102.

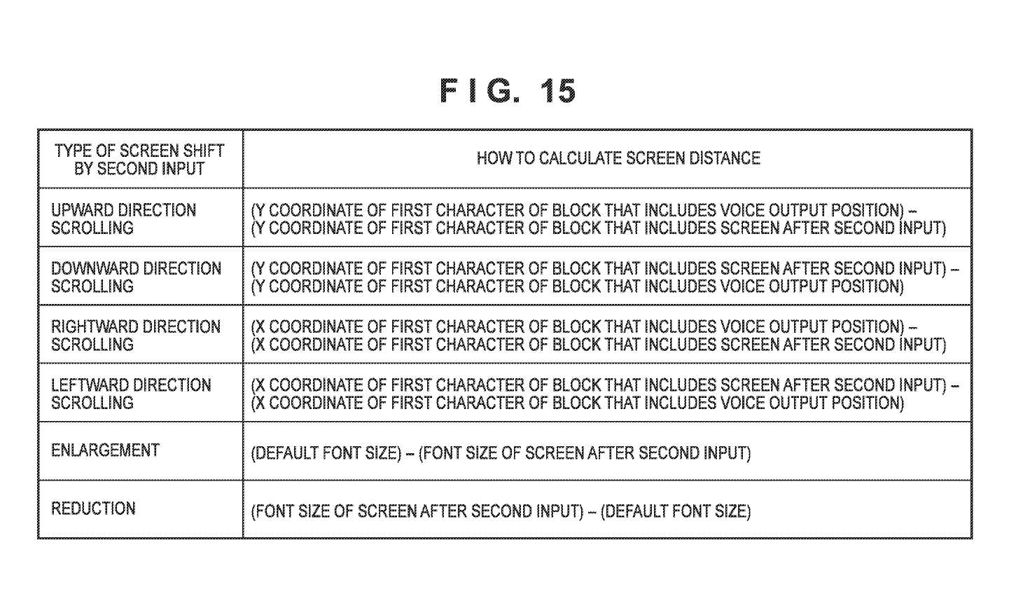

The screen distance specifying unit 211 specifies (calculates) a distance on the screen between the voice output position screen and the screen after input. In the present embodiment, the screen distance is specified differently depending on the operation type of the second input, as shown in FIG. 15. Like the first character 1600 in FIG. 16, a character region is defined for each character, and coordinates in the center of each region serve as coordinates of the corresponding character.

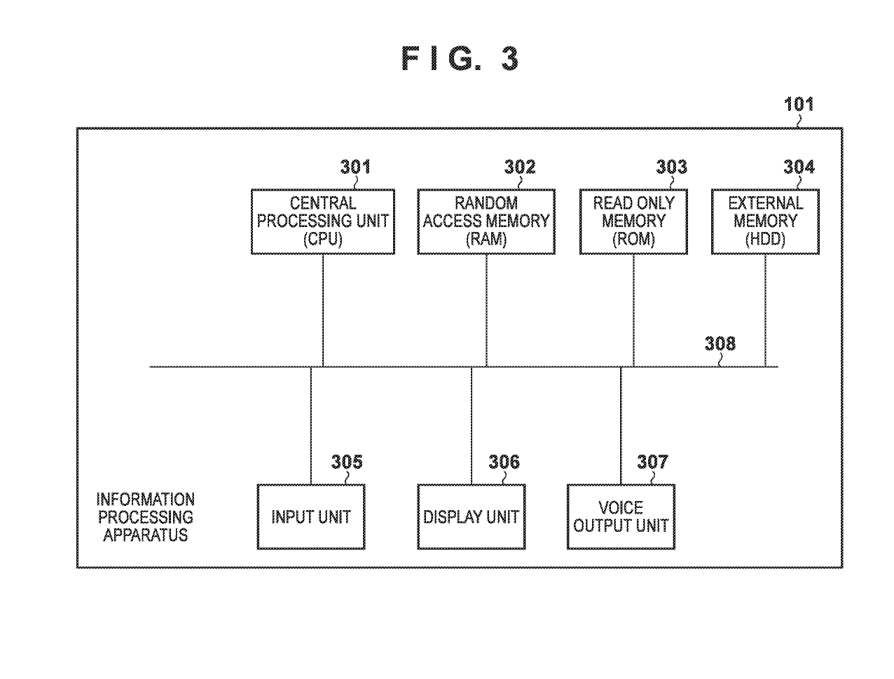

Every unit illustrated in FIG. 1 may be configured by hardware, but it is also possible that, for example, the voice output position storage unit 203 is configured by a memory, and all other units may be configured by software (a computer program). In such a case, an example of the hardware configuration of the computer that is applicable to the information processing apparatus 101 will be described with reference to the block diagram of FIG. 3.

A CPU 301 performs overall control of operations of the computer with the use of a computer program and data that are stored in a RAM 302 and a ROM 303, and executes the processing that has been described above as being executed by the information processing apparatus 101. The RAM 302 includes an area for temporarily storing a computer program and data that are loaded from an external memory 304 such as a hard disk drive (HDD), and a work area used when the CPU 301 executes various types of processing. That is, the RAM 302 can suitably provide various types of areas. The ROM 303 has stored therein setting data of the computer, a boot program, and the like. The input unit 305 corresponds to the voice output button 104, the touch sensor on the touch panel 102, or the acceleration sensor 106 and can input, as described above, various types of instructions to the CPU 301. The display unit 306 corresponds to the touch panel 102. The voice output unit 307 corresponds to the speaker 103. The external memory 304 has stored therein an operating system (OS), data, and computer programs for causing the CPU 301 to execute the various types of processing as described in the above embodiment. These computer programs include computer programs that respectively correspond to the units in FIG. 1 (excluding the voice output position storage unit 203). Also, this data includes data on the electronic book content and the data that was described as being well-known in the above-described processing. The computer programs and the data stored in the external memory 304 are suitably loaded in the RAM 302 in accordance with the control of the CPU 301 and are processed by the CPU 301. The above-described units are connected to a common bus 308. Note that the voice output position storage unit 203 corresponds to the external memory 304 or the RAM 302. Also, the information processing apparatus including the functional configuration illustrated in FIG. 1 may be implemented by a single computer having the configuration shown in FIG. 3 or may be configured by a plurality of the devices. Note that some rather than all of the units illustrated in FIG. 1 may be configured by hardware/software. Even in this case, this software is stored in the memory and executed by the CPU 301.

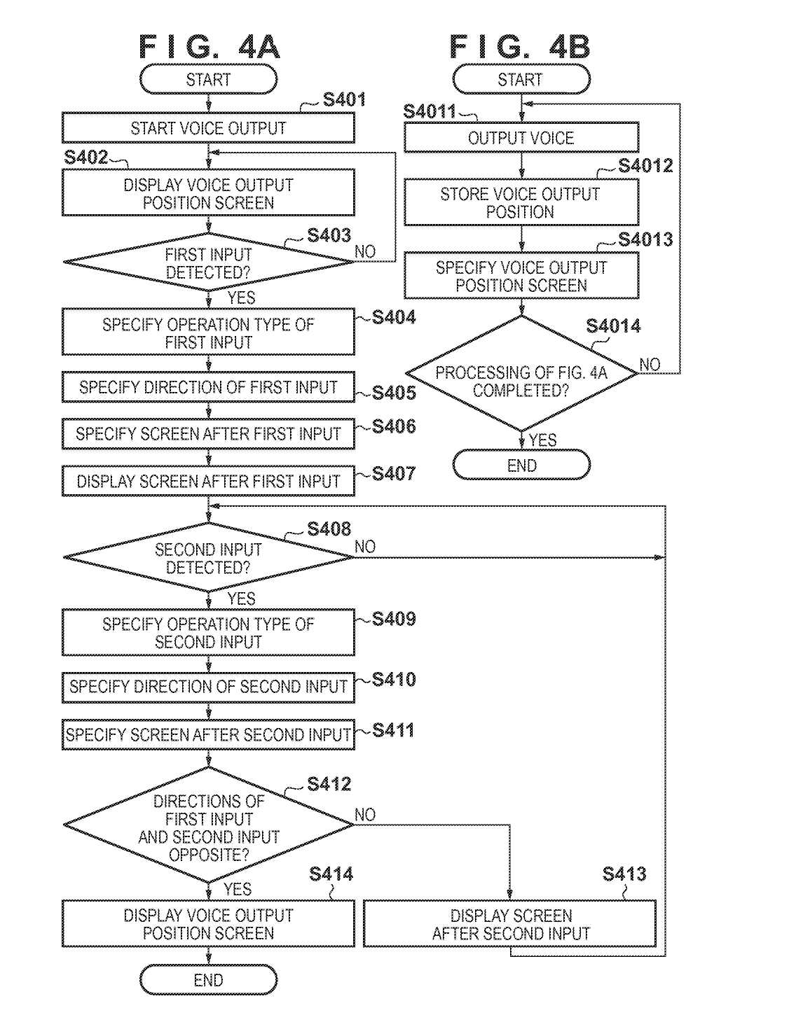

Next, processing performed by the information processing apparatus 101 according to the present embodiment will be described with reference to FIG. 4A that illustrates a flowchart of the processing. Note that in the following description, it is assumed that a text of a block whose block ID is “1” on a page of the page number N (N≧1) (refereed to as “page N”) of the electronic book content is displayed on the touch panel 102, and this text of the block whose block ID is “1” on this N page has not yet been output as voice. Also, the block whose block ID is “1” is displayed so as to be located at the upper left end, and the text has a font size of 4 mm as described above. When the user presses the voice output button 104 in this state, the processing in steps S401 onward will be started.

In step S401, when the input unit 201 detects the voice output button 104 being pressed, the voice output unit 202 starts outputting voice from the voice output start position (the first character of the block whose block ID is 1).

When voice output has been started in step S401, the processing in a flowchart of FIG. 4B (for example, a thread) is continuously performed until the processing of a flowchart of FIG. 4A ends. Hereinafter, the flowchart of FIG. 4B is described.

In step S4011, the voice output unit 202 generates, with respect to each of the characters from the first character onward of the block whose block ID is 1, a voice signal based on the voice waveform data of the character, and supplies the generated voice signal to the speaker 103. That is, in the present step, when the voice output instruction is input by the voice output button 104 being pressed, the page N displayed on the touch panel 102 at the time of the input is taken as a voice output page, and voice that corresponds to characters on the voice output page is sequentially output in the arrangement order of the characters.

In step S4012, the voice output position storage unit 203 stores information for specifying a voice output position of a block whose ID is N where voice is to be output by the voice output unit 202. That is, in the present step, information for specifying a voice output position on a voice output page where voice is to be output by the voice output unit 202 is managed in the memory (voice output position storage unit 203).

In step S4013, the first screen specifying unit 204 specifies a voice output position screen that corresponds to the voice output position stored in the voice output position storage unit 203.

In step S4014, it is determined whether or not the processing of FIG. 4A was completed. If it is determined that the processing was completed, the processing of FIG. 4B also ends. If otherwise determined, the processing of step S4011 is performed.

Now, in step S402, the display unit 210 supplies the video signal of the voice output position screen that was specified by the first screen specifying unit 204 to the touch panel 102.

In step S403, the input unit 201 detects an input (first input) by the user from the touch panel 102, the acceleration sensor 106, and the camera 105. If the input unit 201 detects the input, the processing of step S404 is performed. If the input unit 201 does not detect the input, the processing of step S402 is performed.

In step S404, the input unit 201 specifies an operation type of the first input. In step S405, the input unit 201 specifies a direction of the first input based on the operation type of the first input. In step S406, the second screen specifying unit 205 specifies a screen after first input on the basis of the first input. In step S407, the display unit 210 supplies a video signal of the screen after first input to the touch panel 102. As a result, the text on the position that corresponds to the first input is displayed. Note that even when this first input is made, voice output is continuing.

In step S408, the input unit 201 specifies an operation type of the second input. In step S409, the input unit 201 specifies a direction of the second input based on the operation type of the second input. In step S410, the second screen specifying unit 205 specifies, based on the second input, a screen after second input. In step S411, the display unit 210 supplies a video signal of the screen after second input to the touch panel 102.

In step S412, the opposite direction determination unit 207 determines whether or not the directions of the first input and the second input are opposite to each other. If the opposite direction determination unit 207 has determined that the directions are opposite to each other, the processing of step S414 is performed. If the opposite direction determination unit 207 has determined that the directions are not opposite to each other, the processing of step S413 is performed.

In step S413, the display unit 210 supplies a video signal of the screen after second input to the touch panel 102.

In step S414, the display unit 210 supplies a video signal of the voice output position screen at the present moment to the touch panel 102.

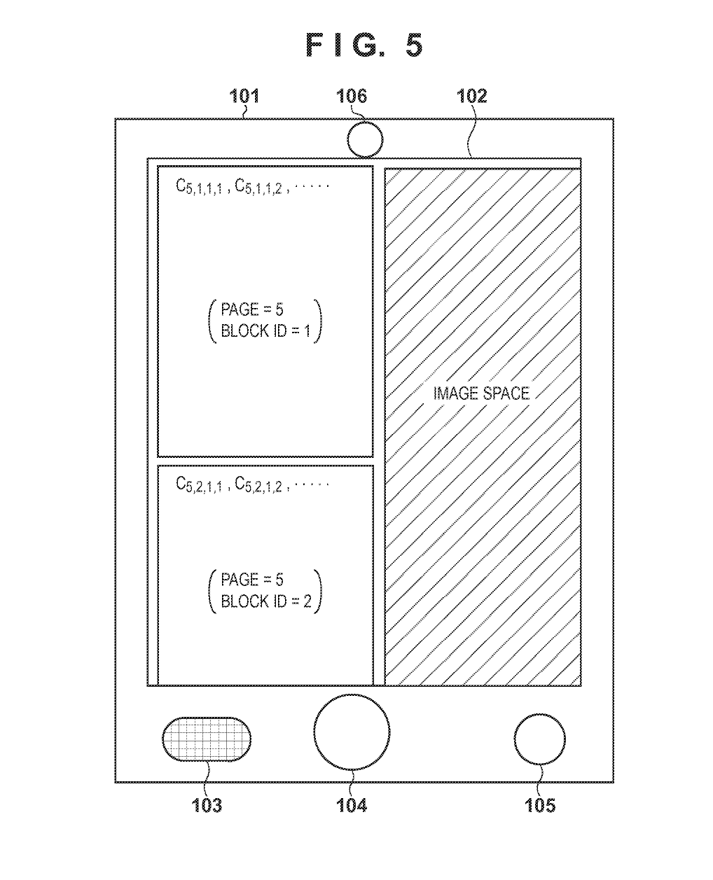

Hereinafter, the case where N=5 is described as an example. FIG. 5 illustrates an example of display of the page N on the touch panel 102. For the sake of illustration, texts in the blocks whose IDs are 1 and 2 on page 5 are illustrated.

In step S401, the input unit 201 detects the button being pressed by the user and performs the processing of step S4011. In step S4011, the voice output unit 202 refers the information in the voice output position storage unit 203 to SMIL description information, and starts outputting voice from the first character C_{5,1,1,1} in the first line of the block whose ID is 1 on page 5. Thereafter, the voice waveform data of C_{5,1,1,2}, C_{5,1,1,3} onward are sequentially output as voice.

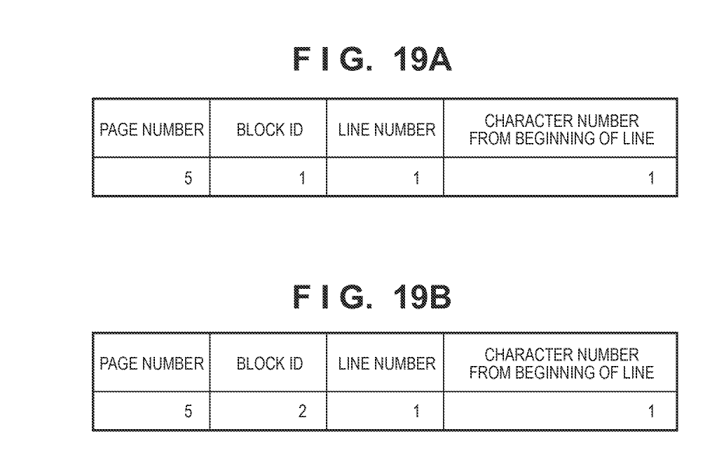

An example of the information structure at this time that is to be registered in the voice output position storage unit 203 in step S4012 is illustrated in FIG. 19A. As described above, since the voice output has just been started, the page number “5” and the position of the first character (the line number “1” and the character number “1” from the first character of the line “1”) of the block whose ID is “1” on page 5 are registered as a voice output position in the voice output position storage unit 203.

At the same time, since in step S4013 the block ID of the block that includes the voice output position is “1”, the first screen specifying unit 204 specifies the voice output position screen such that the first character of the block whose block ID is 1 is located at the upper left end of the touch panel 102, as shown in FIG. 5. Also, in step S402, as shown in FIG. 5, the voice output position screen is displayed on the touch panel 102.

Also, when voice output advances in the order of arrangement of characters, the voice output position is updated in synchronization therewith.

Then, it is assumed that the user performs a downward direction flick operation on the touch panel 102. In this case, in step S404, the input unit 201 specifies the downward direction flick operation as an operation type of the first input. Also, in step S405, the downward direction is specified as a direction of the first input. Also, in step S406, a screen after first input obtained by downward scroll movement by the downward direction flick operation is specified.

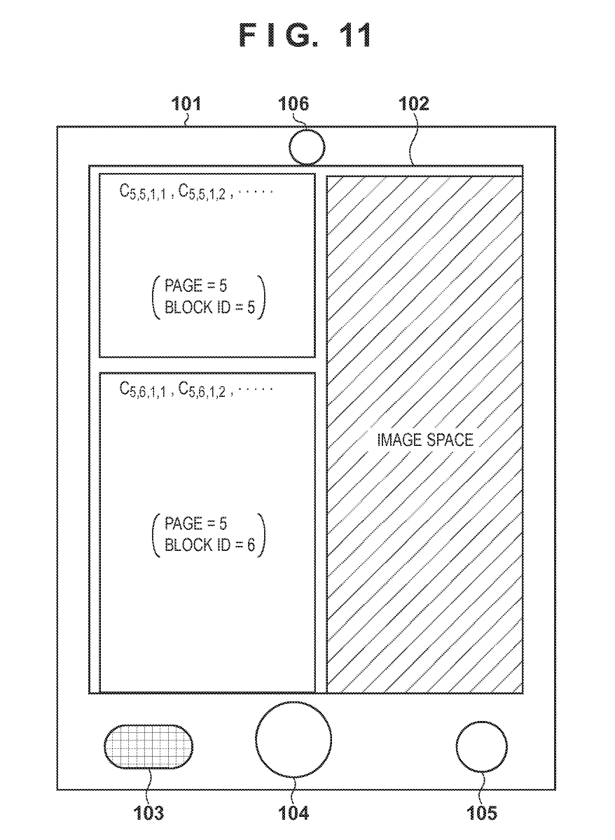

In step S407, the screen after first input is displayed on the touch panel 102 in response to the scroll movement. Here, the screen after first input that was subjected to the scroll movement is such that, as shown in FIG. 11, the first character of the block whose block ID is 5 on page 5 is located at the upper left end of the touch panel 102.

Further, thereafter, the user performs an upward direction flick operation on the touch panel 102.

In step S409, the input unit 201 specifies the upward direction flick operation as an operation type of the second input. Also, in step S410, the upward direction is specified as a direction of the second input. Also, in step S411, the screen after second input obtained by upward scroll movement by the upward direction flick operation is specified.

In step S412, it is determined that the directions of the first input and the second input are respectively the downward direction and the upward direction, that is, the directions are opposite to each other. Accordingly, the processing of step S414 is performed.

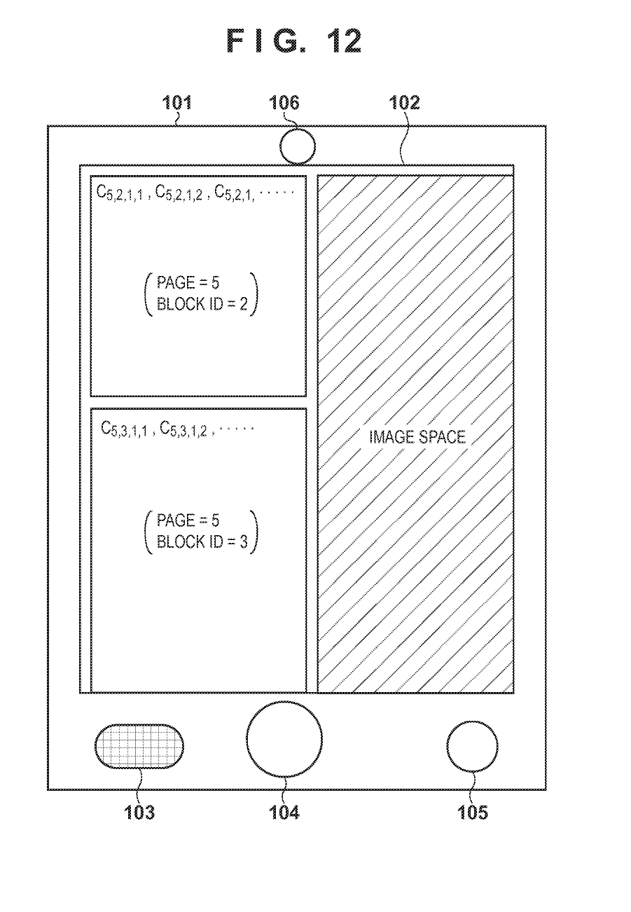

At this time, it is assumed in step S4011 that voice output has shifted to the first character of the block whose ID is 2 on page 5. Therefore, in step S4012, the page number “5” and the position of the first character (the line number “1” and the character number from the first character of the line “1”) of the block whose ID is “2” on page 5 are registered as a voice output position in the voice output position storage unit 203. At the same time, since in step S4013 the block ID of the block that includes the voice output position is “2”, the first screen specifying unit 204 specifies the voice output position screen such that the first character C_{5,2,1,1} of the block whose ID is “2” on page 5 of FIG. 5 is located at the upper left end on the touch panel 102. Also, in step S402, as shown in FIG. 12, the voice output position screen is displayed on the touch panel 102.

That is, immediately after screen shift is made in response to the first input, the voice output position screen can be displayed in response to the second input. Also, according to the direction of the input, it is possible to switch the display between the voice output position screen and the screen after input. In particular, if the first input and the second input have the same input operation type, it is possible to switch the display between the voice output position screen and the screen after input with the same type of input.

Note that although the above example has described only the directions of the first input and the second input, a configuration is possible in which, for example, an input that is made within a preset time period from the first input may be determined as the second input.

Modification 1

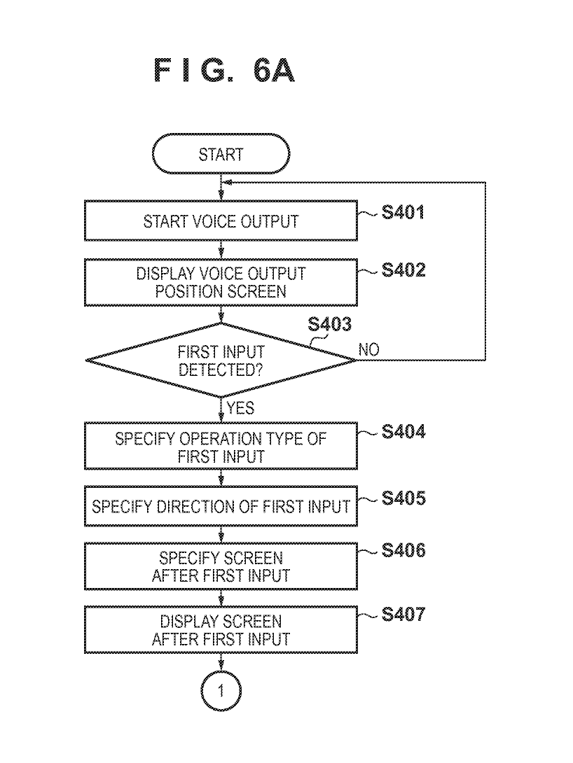

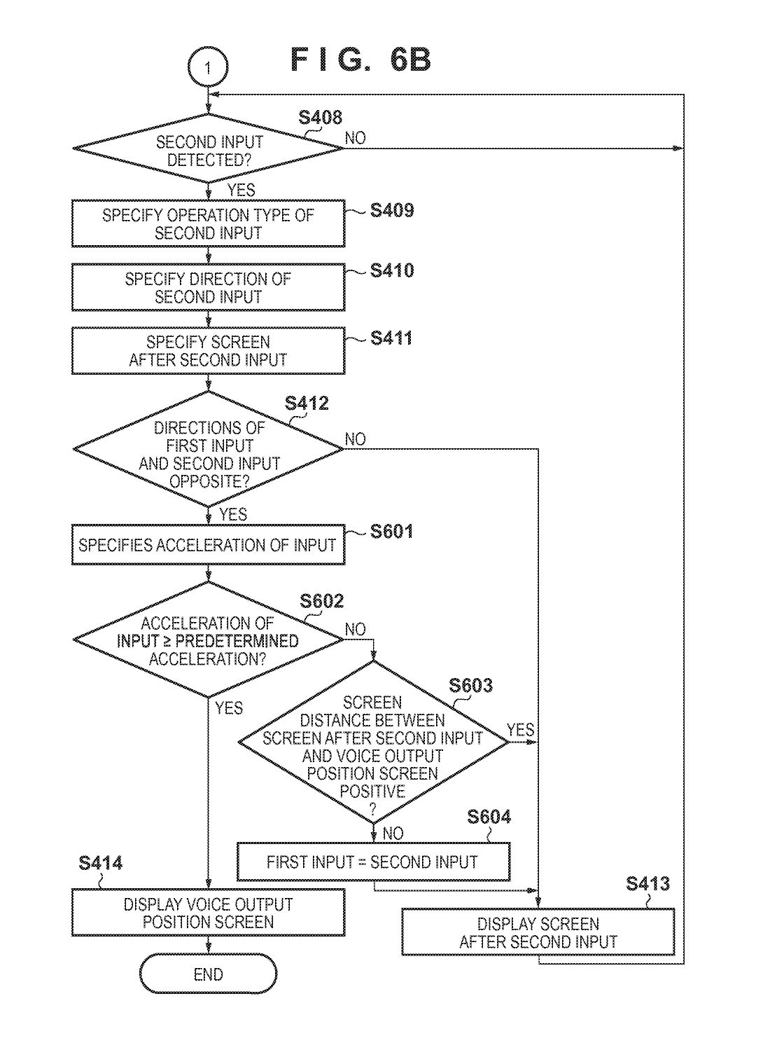

In step S412, the display is switched between the voice output position screen and the screen after first input depending on whether or not the directions of the first input and the second input are opposite to each other. In addition to this, the acceleration of the second input may be added to the condition for the determination. This modification will be described with reference to flowcharts of FIGS. 6A and 6B. In FIGS. 6A and 6B, the same step numbers are given to the same processing steps as those of FIG. 4, and descriptions thereof are omitted. The processes of steps S601 to S604 are added to the flowcharts of FIGS. 6A and 6B.

In step S601, the acceleration specifying unit 208 specifies an acceleration of the second input.

In step S602, the display control unit 209 determines whether or not the acceleration of the second input is a predetermined acceleration or greater (a threshold or greater). If the display control unit 209 has determined that the acceleration of the second input is a predetermined acceleration or greater, the processing of step S414 is performed. If the display control unit 209 has determined that the acceleration of the second input is not greater than a predetermined acceleration, the processing of step S603 is performed.

In step S603, the screen distance specifying unit 211 specifies a screen distance between the screen after second input and the voice output position screen. Then, the display control unit 209 determines whether or not the screen distance specified by the specifying unit 211 is a positive. If the display control unit 209 has determined that the screen distance is a positive, the processing of step S413 is performed. If the display control unit 209 has determined that the screen distance is not a positive, the processing of step S604 is performed.

In step S604, the display control unit 209 takes the second input as the first input.

That is, it is possible to switch the display between the voice output position screen and the screen after input according to the determination of whether or not the directions of the first input and the second input are opposite directions, and the acceleration of the second input.

Also, when, for example, by the processing of steps S603 and S604, scrolling in the downward direction is made in response to the first input (a downward direction scrolling operation), and then scrolling in the upward direction is made in response to the second input (an upward direction scrolling) and continues beyond the voice output position screen, the second input is taken as the first input (the second input becomes the first input). Thereafter, when a new second input (downward direction scrolling) is made with the predetermined acceleration or greater, the voice output position screen is displayed.

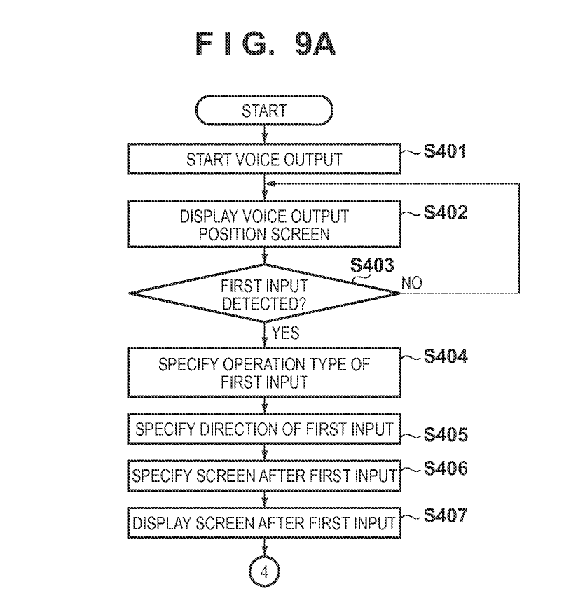

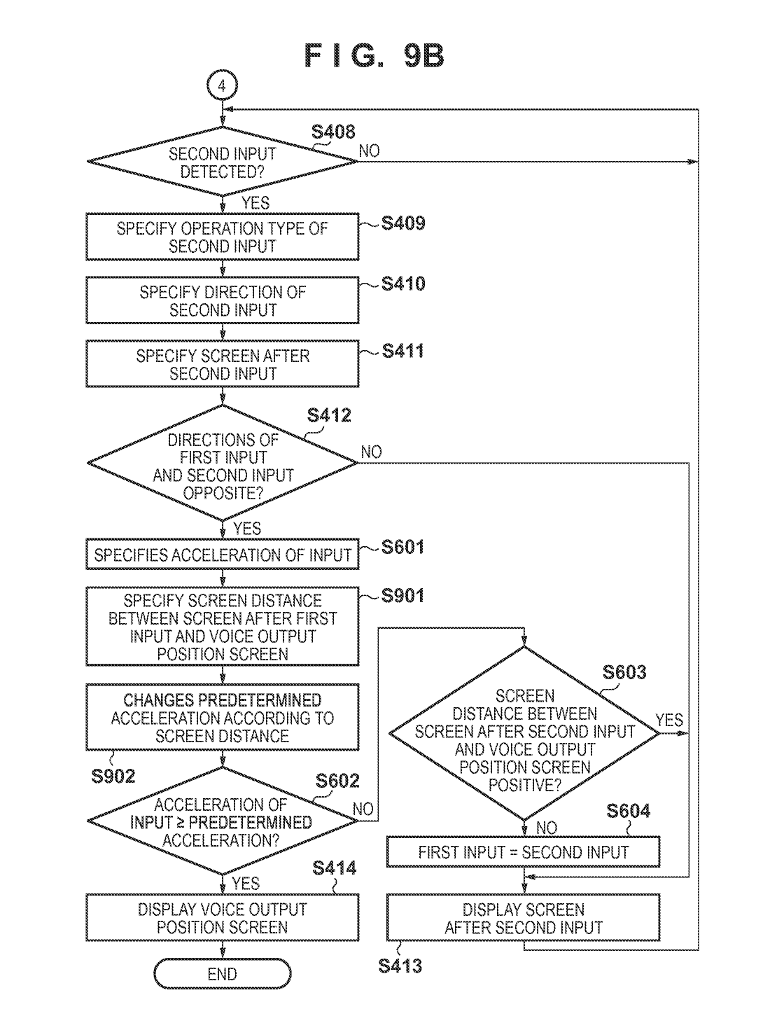

Further, the predetermined acceleration that is used in step S602 may be varied according to the screen distance between the screen after first input and the voice output position screen. This modification will be described with reference to flowcharts of FIGS. 9A and 9B. In FIGS. 9A and 9B, the same step numbers are given to the same processing steps as those in FIGS. 6A and 6B, and descriptions thereof are omitted. The flowcharts of FIGS. 9A and 9B include the processes of steps S901 and S902.

In step S901, the screen distance specifying unit 211 specifies the screen distance between the screen after first input and the voice output position screen. In step S902, the display control unit 209 changes the predetermined acceleration according to the screen distance specified by the screen distance specifying unit 211. For example, it is conceivable to change the predetermined acceleration to that obtained by multiplying the default by 2 if the absolute value of the screen distance is 6 or greater.

That is, it is possible to change the predetermined acceleration according to the shift amount due to the first input. For example, in order to display the voice output position screen in step S414, the second input needs to have a greater acceleration in the case where the amount of screen shift due to the first input is large than in the case where the amount of screen shift is small.

Modification 2

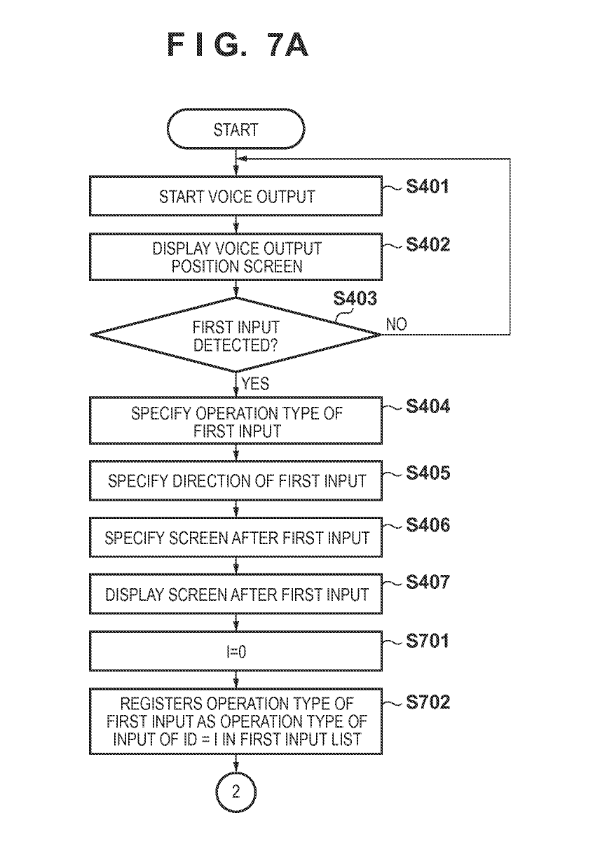

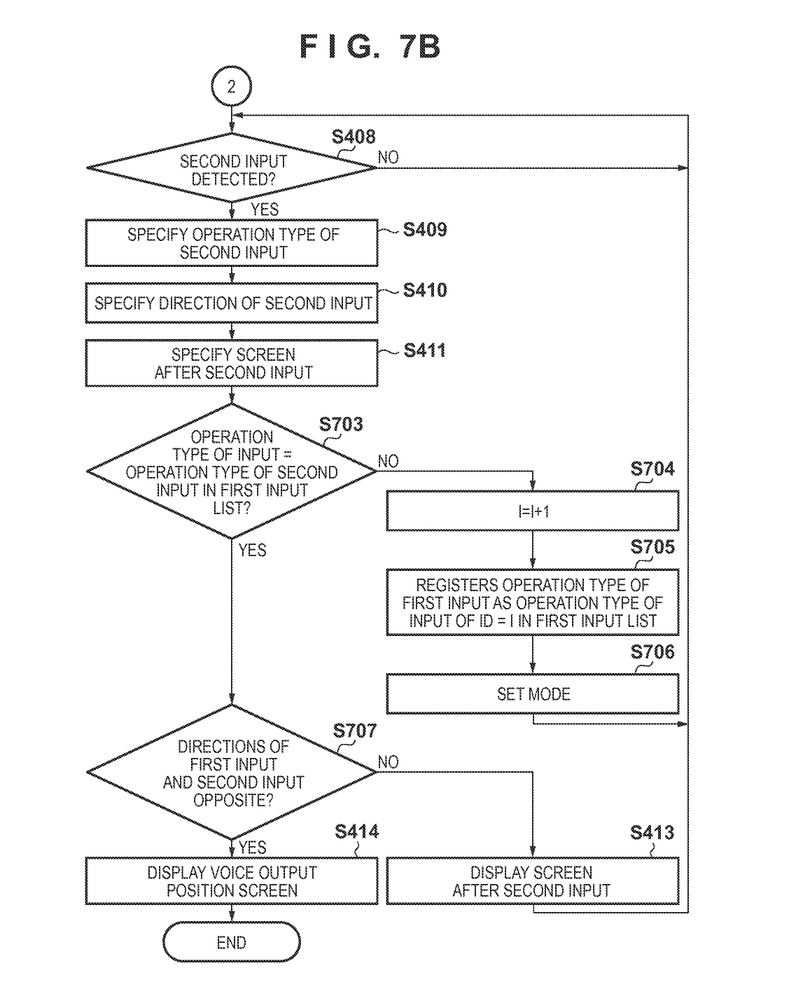

The processing of the flowchart of FIG. 4 has described the case of a single first input. Modification 2 will describe the case of a plurality of first inputs with reference to flowcharts of FIGS. 7A and 7B. In FIGS. 7A and 7B, the same step numbers are given to the same processing steps as those of FIG. 4, and descriptions thereof are omitted. The flowcharts of FIGS. 7A and 7B include processing of steps S701 to S707. Also, the processing of step S412 is replaced by the processing of step S707.

In step S701, the input unit 201 sets I=0. In step S702, the input unit 201 registers the operation type of the first input for an operation type of the input of ID=I, as a first input list, and stores the first input list in the memory.

In step S703, the display control unit 209 refers to the first input list, and determines whether or not the first input list includes the operation type of the second input. If the display control unit 209 has determined that the first input list includes the operation type of the second input, the processing of step S707 is performed. If the display control unit 209 has determined that the first input list does not include the operation type of the second input, the processing of step S707 is performed. If the display control unit 209 has determined that the first input list does not include the operation type of the second input, the processing of step S704 is performed.

In step S704, the input unit 201 increments I by 1. The processing of step S705 is the same as the processing of step S702. In step S706, the display control unit 209 performs mode setting. (Note that, with respect to the mode setting, the user itself has designated a first mode or a second mode before the processing of FIGS. 7A and 7B is started.)

In step S707, the opposite direction determination unit 207 determines, according to the set mode, whether or not the directions of the first input and the second input are opposite to each other. If the opposite direction determination unit 207 has determined that the directions are opposite to each other, the processing of step S414 is performed. If the opposite direction determination unit 207 has determined that the directions are not opposite to each other, the processing of step S413 is performed.

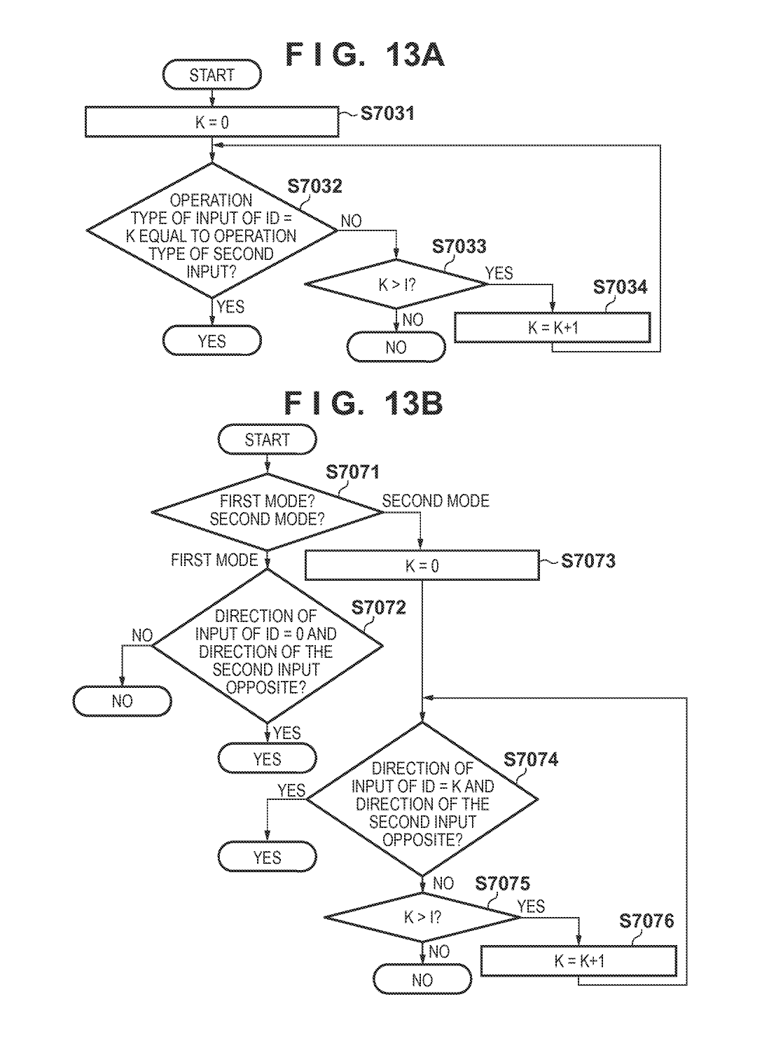

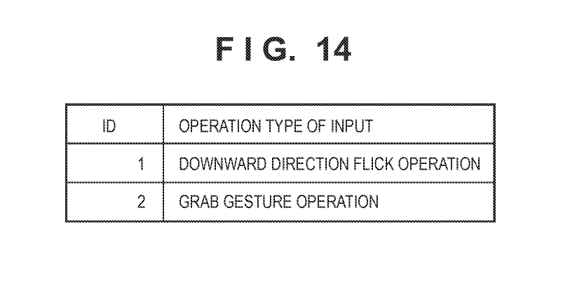

Here, the specified processing of step S703 will be described with reference to a flowchart of FIG. 13A.

In step S7031, the display control unit 209 sets K=0. In step S7032, the display control unit 209 determines whether or not the operation type of the input of ID=K and the operation type of the second input are equivalent in the first input list. If the display control unit 209 has determined that the operation type of the input of ID=K is the same as the operation type of the second input, it is determined in step S703 that the first input list includes the operation type of the second input. If the display control unit 209 has determined that the operation type of the input of ID=K is not the same as the operation type of the second input, the processing of step S7033 is performed.

In step S7033, the display control unit 209 determines whether or not K>I. If the display control unit 209 has determined that K>I, the processing of step S703 is performed. In the case where the display control unit 209 has determined that K>I, it is determined in step S703 that the first input list does not include the operation type of the second input. If the display control unit 209 has determined that K>I is not true, the processing of step S7034 is performed. In step S7034, the display control unit 209 increments K by 1.

Also, the specified processing of step S707 will be described with reference to a flowchart of FIG. 13B.

In step S7071, the display control unit 209 determines whether the set mode is the first mode or the second mode. If the display control unit 209 has determined that the set mode is the first mode, the processing of step S7072 is performed. If the display control unit 209 has determined that the set mode is the second mode, the processing of step S7073 is performed.

In step S7072, the display control unit 209 specifies a direction of the operation type of the input of ID=0, with reference to the dictionary data. Then, the display control unit 209 determines whether or not the specified input direction and the direction of the second input are opposite directions. If the display control unit 209 has determined that the specified input direction and the direction of the second input are opposite directions, the processing of step S414 is performed. If the display control unit 209 has determined that the specified input direction and the direction of the second input are not opposite directions, the processing of step S413 is performed.

In step S7073, the display control unit 209 sets K=0. In step S7074, the display control unit 209 specifies a direction of the operation type of the input of ID=K, with reference to the dictionary data. Also, the display control unit 209 determines whether or not the specified input direction and the direction of the second input are opposite directions. If the display control unit 209 has determined that the specified input direction and the direction of the second input are opposite directions, the processing of step S414 is performed. If the display control unit 209 has determined that the specified input direction and the direction of the second input are not opposite directions, the processing of step S7075 is performed.

In step S7075, the display control unit 209 determines whether or not K>I. If the display control unit 209 has determined that K>I, the processing of step S7076 is performed. If the display control unit 209 has determined that K>I is not true, the processing of step S414 is performed. In step S7076, the display control unit 209 increments K by 1.

That is, if the first mode has been designated, only the direction of the input that is firstly registered in the first input list after the processing of FIGS. 7A and 7B has started is taken as the direction of the first input to be determined in step S412. If the second mode has been designated, all the input directions registered in the first input list are taken as the direction of the first input to be determined in step S412. Also, by switching the mode between the first mode and the second mode, it is possible to switch the display between the voice output position screen and the screen after input according to the input operation type of the opposite direction. Therefore, even in the case of a plurality of operation types of inputs, it is possible to switch the display between the voice output position screen and the screen after input according to the second input.

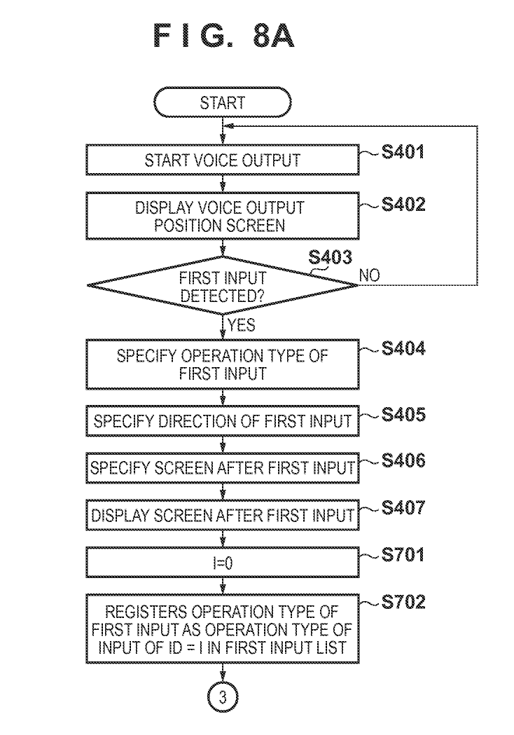

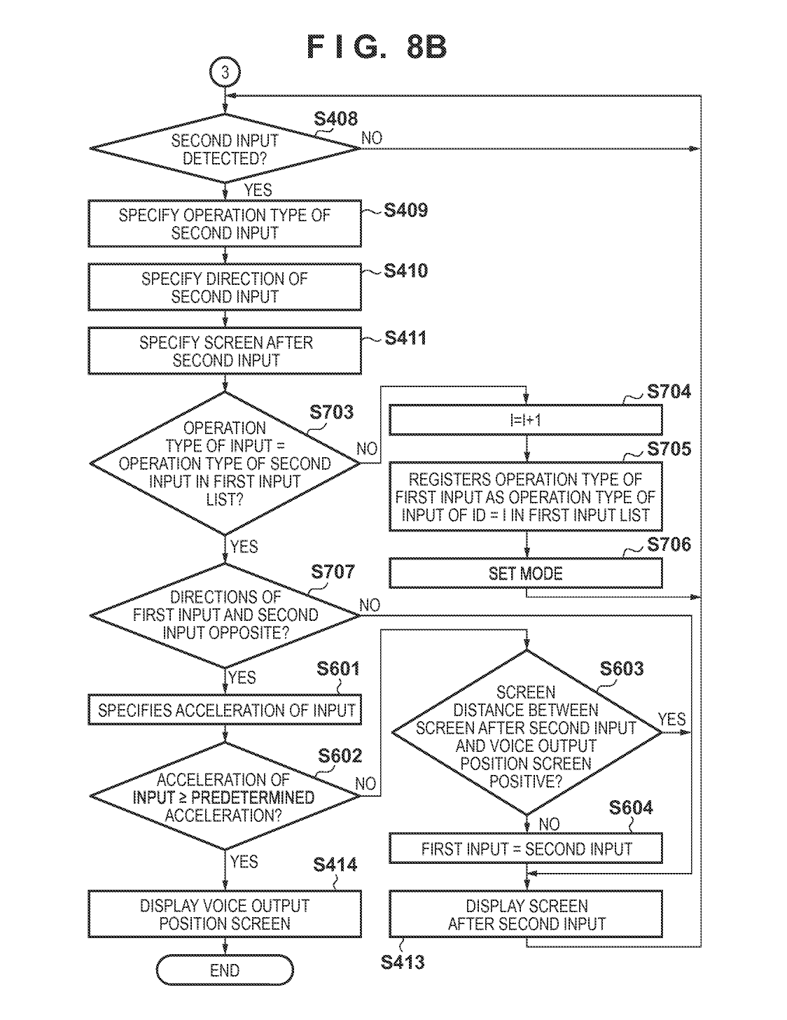

Also, in the processing of FIGS. 7A and 7B, the display is switched between the voice output position screen and the screen after first input according to whether or not the directions of the first input and the second input are opposite to each other. However, the present invention is not limited to this, and the display may be switched between the two screens according to the acceleration of the second input, as shown FIGS. 8A and 8B. Steps of flowcharts of FIGS. 8A and 8B have already been described with reference to the processing of the flowcharts of FIGS. 7A and 7B and 6A and 6B, and descriptions thereof are omitted.

Here, although in the present embodiment voice output is performed from the beginning of the page in step S401, the present invention is not limited to this. A configuration is also possible in which by designating a voice output start position with a touch operation and then pressing the voice output button 104, voice output is performed from the designated voice output start position. Although voice waveform data in which an electronic book content is read aloud is output as voice, a voice synthesis technology may be used to output the electronic book content as voice. However, if the voice synthesis technology is used, in step S407, the voice output position control unit 205 supplies, to the speaker 103, a voice signal based on the voice waveform data of characters that are arranged at the voice output start position onward. For example, it is assumed that the character C_{5,1,2,5} of the page “5”, the block ID “1”, the line number “2”, and the number of character “5” is a character from which voice output is started. At this time, if the character C_{5,1,2,5} is a character that is a part of a meaningful word, unnatural voice is produced. Therefore, before or after the character C_{5,1,2,5} may be checked so as to find the first character of a meaningful word, and then voice output may be started from this position.

Also, in the present embodiment, the touch operation, the gesture operation, and the inclination operation are taken as examples of the input operation type, but the input operation type is not limited to these. The input operation type may be a mouse operation, a voice recognition operation, or the like as long as it can instruct a scroll operation, a zoom operation, or the like.

Also, in the present embodiment, characters and voice are associated with each other, but the present invention is not limited to this. Image data, an icon button, or the like may be associated with voice.

### Other Embodiments

Also, the present invention is realized by executing the following processing. That is, software (a program) that realizes the functions of the above-described embodiments is supplied to a system or an apparatus via a network or various types of storage medium, and a computer (or a CPU, an MPU, etc.) of the system or the apparatus reads out the program and executes the read program.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-226329 filed Oct. 11, 2012, which is hereby incorporated by reference herein in its entirety.

What is claimed is:

1. An information processing apparatus comprising:
a display control unit configured to display a text on a screen;
a voice output unit configured to output the text as voice;
a detection unit configured to detect a first operation and a second operation performed by a user on the screen; and
a determination unit configured to determine whether or not the second operation has a predetermined relationship with the first operation;
wherein the display control unit is configured to control the screen based on determination by the determination unit.

2. The information processing apparatus according to claim 1,
wherein the predetermined relationship is a relationship in which the second operation and the first operation are opposite to each other.

3. The information processing apparatus according to claim 2,
wherein the first operation and the second operation are of the same operation type.

4. The information processing apparatus according to claim 1,
wherein when it is determined by the determination unit that the second operation has the predetermined relationship with the first operation, the screen is controlled so as to include the text that is being output as voice by the voice output unit.

5. The information processing apparatus according to claim 4,
wherein when it is determined by the determination unit that the second operation does not have the predetermined relationship with the first operation, the screen is controlled based on the second operation.

6. The information processing apparatus according to claim 1,
wherein the detection unit is further configured to detect an acceleration of the second operation, and the display control unit is configured to control the screen based on the determination by the determination unit and the acceleration.

7. The information processing apparatus according to claim 6,
wherein when it is determined by the determination unit that the second operation has the predetermined relationship with the first operation, and that the acceleration is a predetermined threshold or greater, the screen is controlled so as to include the text that is being output as voice by the voice output unit.

8. The information processing apparatus according to claim 1,
wherein the first operation is an operation that has been detected prior to the second operation.

9. The information processing apparatus according to claim 1,
wherein the first operation includes a plurality of operations that have been detected prior to the second operation.

10. A method for controlling an information processing apparatus comprising:
a display control step of displaying a text on a screen;
a voice output step of outputting the text as voice;
a detection step of detecting a first operation and a second operation performed by a user on the screen; and
a determination step of determining whether or not the second operation has a predetermined relationship with the first operation;
wherein the display control step controls the screen based on determination in the determination step.

11. The method according to claim 10,
wherein the predetermined relationship is a relationship in which the second operation and the first operation are opposite to each other.

12. The method according to claim 11,
wherein the first operation and the second operation are of the same operation type.

13. The method according to claim 10,
wherein when it is determined in the determination step that the second operation has the predetermined relationship with the first operation, the screen is controlled so as to include the text that is being output as voice in the voice output step.

14. The method according to claim 13,
wherein when it is determined in the determination step that the second operation does not have the predetermined relationship with the first operation, the screen is controlled based on the second operation.

15. The method according to claim 10,
wherein the detection step further detects an acceleration of the second operation, and the display control step controls the screen based on the determination in the determination step and the acceleration.

16. The method according to claim 15,
wherein when it is determined in the determination step that the second operation has the predetermined relationship with the first operation, and that the acceleration is a predetermined threshold or greater, the voice output step controls the screen so as to include the text that is being output as voice.

17. The method according to claim 10,
wherein the first operation is an operation that has been detected prior to the second operation.

18. The method according to claim 10,
wherein the first operation includes a plurality of operations that have been detected prior to the second operation.

19. A non-transitory computer-readable storage medium that has stored therein a program for causing a computer to execute the steps of the method according to claim 10.
